(19) United States
(12) Patent Application Publication
(10) Pub. No.: US 2004/0225599 A1
(43) Pub. Date: Nov. 11, 2004

(54) Financial product

(76) Inventor: Olivier Gerard Constantijn Burgersdijk, Breda (NL)

Correspondence Address: John Richards, Ladas & Parry, 26 West 61 Street, New York, NY, 10023, US

(21) Appl. No.: 10/805,673

(22) Filed: Mar. 19, 2004

(30) Foreign Application Priority Data
Mar. 19, 2003 (NL) 1022967

(51) Int. Cl. G06F 17/60

(52) U.S. Cl. 705/38

(57) ABSTRACT

In a financial product an amount of money is provided as a loan principal in return for the obligation to make periodical loan payments during a term. The amount of the periodical loan payments is periodically adjusted on basis of an index number during at least a part of the loan term. The addition of such an indexing of the periodical loan payments provides applicants for fixed interest rate mortgages, loans and other financial products with an extended freedom of choice. One can choose for a construction in which less interest is paid or for a construction in which a higher loan principal can be obtained. Even a combination of these two options is possible. As a result of this extension of possibilities it is, for example, possible to obtain a higher loan principal without facing irresponsible debt payments. The required financial space is provided by the principle that the periodical loan payments grow along with the index-linked disposable income or profits of the debtor, whereas the fixed interest rate secures proportioned interest costs.

### FIELD OF THE INVENTION

The present invention relates to a financial product in which an amount of money is provided as a loan principal in return for, at least partially, the obligation to make periodical loan payments during a certain term, in which the amount of the periodical loan payments is index-linked to an index number and in which the interest rate has a long term fixed character. Although both fixed rate loans and index-linked repayment schedules have been applied in the past, the unexpected combination of these two elements is new and so are its effects for both debtor and lender.

### BACKGROUND OF THE INVENTION

Fixed interest rates are quite common. The opposite is true for commercially successful applications of loans in which the periodical loan payments are index-linked. A very impressive calculation was used in the index-linked mortgage as described by its inventor Michael Kelly in appendix A of his book “Mortgages exposed” available on line at (www.mortgagesexposed.com). The author describes the rise and fall of this mortgage type which was launched in the late 1970's in England. This kind of financing real estate has also been applied in Canada and Denmark, where it was used for social housing programs. Government subsidies were required to attract investments. The main reason for the lack of commercial success of index-linked repayment loans in the past is the combination with other index-linked parameters, like the interest rate and sometimes even the loan principal. This combination of index-linked elements makes such a product very sensitive to economical developments. And when it comes to especially long term financial agreements, both lenders and debtors prefer security to adventure. The present invention provides this security. Thanks to the fixed interest rate a steep rise in prices and interest rates no longer threatens a debtor. Instead the rising inflation speeds up the amortization process due to which less interest is paid over the entire term. For the lender this means that the investment is earlier available for reinvestment against a higher yield. Compared to existing fixed interest rate loans the invention provides the advantage of offering a more customizable financial product which uses the gradually growing financial space of the debtor to either realize a higher loan principal or to reduce interest costs or even both.

Financial products related to loans are a very current tool in financing real estate, cars and means of production. Worldwide financial institutions provide loans on an enormous scale. These loans may vary in many ways. For instance some loans may be given in relation to a mortgage, some have a fixed interest rate while other loans have adjustable rates and, of course, there could be a kind of gradual amortization during the loan term. In most cases the debtor is obliged to make periodical, usually monthly, loan payments during the term the loan is agreed to upfront. The amount of this periodical loan payment depends on the loan principal, amortization, possibly commission or other related costs, the term of the agreement and the interest rate. Financial institutions usually grant loans when there is an acceptable ratio between the periodical loan payments and the financial means of the debtor. And thus a maximum loan principal is established.

Although the financial strength of the debtor is taken into serious consideration, still the objection can be made that these loan-qualification requirements are based on the debtor's financial means at a given moment in time. Little consideration is given to the most likely development of the profits or income of the debtor during the term of the loan, which might last for several decades.

The invention is, among other things, meant to provide a financial product of the kind mentioned in the opening of this description that takes the growth of the profits or income of the debtor during the term of the loan into account in a reasonable way.

### SUMMARY OF THE INVENTION

In order to achieve this objective a financial product in accordance with the present invention has the distinctive feature that the amount of the periodical loan payments is at least during a part of the loan term index-linked to an index number, which refers to a economic development like inflation or the development of real property value, an income index or any branch-relevant index.

Accordingly the present invention provides financial product, in which an amount of money is provided as a loan principal in return for, at least partially, the obligation to make periodical payments on the loan during a term, wherein the amount of the periodical payments is index-linked during at least a part of the loan term to an index number, which refers to economical development and wherein the interest rate has a long term fixed character.

By use of such an index based on economic development, the invention adds an extra parameter to the existing set of parameters that is normally used for the underwriting of fixed interest rate loan applications. A quite common application of a financial product in accordance with the invention is featured by the linking of the periodical loan payments to a price index number. A price index number is a parameter based on the general development of living costs. As incomes and prices often are related to this index number a periodical adjustment of the loan payment based on this very index number will hardly affect the effective disposable income. That way the invention results in the maintenance of a reasonable ratio between the means of the debtor and the periodical loan payments over time. Nevertheless a gradual increase of the periodical loan payments allows the granting of a higher loan principal, allows lower monthly loan payments at the start of the loan term, allows either an increase of the amortization during the loan term or a shortened loan term or even a combination of these effects. By indexing the periodical loan payments on basis of the price index number to which normally also the profits or income of the debtor are linked, these periodical loan payments maintain at least in general the effective value they had compared to the income of the debtor at the start of the loan term. And with this the invention extends the freedom of choice regarding especially fixed interest rate loans which can be utilized in several respects.

### DETAILED DESCRIPTION OF THE INVENTION

A price index number can be composed in many ways and therefore there are various index numbers available. For loans granted for personal consumption or for private residential investments the price index number of living costs can be used as a reference, whereas for corporate loans an index number can be used which is based on the development of production costs, such as raw material, energy and wages, which normally lead to a comparable development of sales numbers. Each index number, with or without a focus on a specific branch, is based on a specially composed selection of products and services of which the price development is monitored. A more general approach is chosen in the most common application of the loan in accordance with the invention, which is featured by the use of an average inflation rate over an elapsed period of time. In contrast to the many different forms and sorts of specific index numbers, inflation rates can be applied in a relatively objective and unambiguous way.

The periodical indexing of the loan payments as an element of the invention can be based on the true price development, however, a special application of the financial product in accordance with the invention has the distinctive feature that the index number reflects a forecast of the annual inflation. For instance, the inflation forecast can be deducted from the average inflation rate over a number of recent years. By thus agreeing upfront to a fixed index number the loan in accordance with the invention provides more security to both parties. The specific feature of a long term fixed index number is also contained by a special application of a financial product in accordance with the invention.

In theory the periodical indexing of the periodical loan payments could be applied as often as periodical payments are due in the sense that both periods run simultaneously. However, to reduce the administrative costs it would be preferable if the periodical adjustment to the index number were to be set on a considerably lower frequency than the frequency of the periodical loan payments. Therefore, yet another special application of the financial product in accordance with the invention has the distinctive feature of a monthly frequency of the periodical loan payments and an annual frequency of the adjustment of the periodical loan payments to the price index number, and more specifically that the amount of the monthly loan payment is fixed for the period of a year until the next annual adjustment is made.

In the following sections of this description the invention will be further explained on basis of a few practical examples. In each of these cases the basic assumption is that it concerns a financial product related to a mortgage loan with a term of thirty years and a monthly loan payment by the debtor. Nevertheless, the invention can also be applied on mortgage loans with a shorter or longer term and on mortgage loans with a different frequency of the periodic loan payments. And also the invention can be applied on other loan types. In each of the following arithmetic tables another basic assumption is that a higher ratio than 30% of the gross monthly income required for the monthly loan payment is irresponsible. However, also in this respect the invention can be applied in cases, where other debt-income ratios might be chosen.

Computation of the periodic payments due may be effected in any convenient manner, for example on a computer.

### Conventional Loan

In this practical example it is assumed that the debtor has an annual income of $40,000. Based on this income a loan is granted for which a monthly loan payment is made to the extent of a maximum debt-income ratio of 30%. This results in a maximum loan principal of a little over $165,000 and a monthly loan payment of $1,000. The repayment schedule of this loan is shown in the following table, provided that the loan term is set on 30 years and the effective interest rate is fixed at 6% per year.

| | | | | | Loan | Debt- |
|---|---|---|---|---|---|---|
| | Annual | Loan | Interest/ | Amorti- | payment/ | income |
| Year | income | principal | month | zation/month | month | ratio |
| 1 | $40,000 | $165,178 | $825.89 | $174.11 | $1,000.00 | 30% |
| 2 | $40,000 | $163,089 | $815.44 | $184.56 | $1,000.00 | 30% |
| 3 | $40,000 | $160,874 | $804.37 | $195.63 | $1,000.00 | 30% |
| 4 | $40,000 | $158,526 | $792.63 | $207.37 | $1,000.00 | 30% |
| 5 | $40,000 | $156,038 | $780.19 | $219.81 | $1,000.00 | 30% |
| 6 | $40,000 | $153,400 | $767.00 | $233.00 | $1,000.00 | 30% |
| 7 | $40,000 | $150,604 | $753.02 | $246.98 | $1,000.00 | 30% |
| 8 | $40,000 | $147,641 | $738.20 | $261.80 | $1,000.00 | 30% |
| 9 | $40,000 | $144,499 | $722.50 | $277.50 | $1,000.00 | 30% |
| 10 | $40,000 | $141,169 | $705.84 | $294.16 | $1,000.00 | 30% |
| 11 | $40,000 | $137,639 | $688.20 | $311.80 | $1,000.00 | 30% |
| 12 | $40,000 | $133,897 | $669.49 | $330.51 | $1,000.00 | 30% |
| 13 | $40,000 | $129,931 | $649.66 | $350.34 | $1,000.00 | 30% |
| 14 | $40,000 | $125,727 | $628.64 | $371.36 | $1,000.00 | 30% |
| 15 | $40,000 | $121,271 | $606.35 | $393.65 | $1,000.00 | 30% |
| 16 | $40,000 | $116,547 | $582.74 | $417.26 | $1,000.00 | 30% |
| 17 | $40,000 | $111,540 | $557.70 | $442.30 | $1,000.00 | 30% |
| 18 | $40,000 | $106,232 | $531.16 | $468.84 | $1,000.00 | 30% |
| 19 | $40,000 | $100,606 | $503.03 | $496.97 | $1,000.00 | 30% |
| 20 | $40,000 | $94,643 | $473.21 | $526.79 | $1,000.00 | 30% |
| 21 | $40,000 | $88,321 | $441.61 | $558.39 | $1,000.00 | 30% |
| 22 | $40,000 | $81,620 | $408.10 | $591.90 | $1,000.00 | 30% |
| 23 | $40,000 | $74,518 | $372.59 | $627.41 | $1,000.00 | 30% |
| 24 | $40,000 | $66,989 | $334.94 | $665.06 | $1,000.00 | 30% |
| 25 | $40,000 | $59,008 | $295.04 | $704.96 | $1,000.00 | 30% |
| 26 | $40,000 | $50,548 | $252.74 | $747.26 | $1,000.00 | 30% |
| 27 | $40,000 | $41,581 | $207.91 | $792.09 | $1,000.00 | 30% |
| 28 | $40,000 | $32,076 | $160.38 | $839.62 | $1,000.00 | 30% |
| 29 | $40,000 | $22,001 | $110.00 | $890.00 | $1,000.00 | 30% |
| 30 | $40,000 | $11,321 | $56.60 | $943.40 | $1,000.00 | 30% |
| | | $0 | | Σ = | | |
| | | | | $165,178 | | |

The columns in the table show consecutively the year since the start of the loan term, the annual income of the debtor, the remaining loan balance at the start of the year, the amount monthly paid for effective interest, the amount monthly paid for amortization, the total monthly loan payment and the debt-income ratio. From the figures in the last column it can be deduced that with an annual income of $40,000 and a loan principal of $165,178 the level of the monthly loan payments will keep the limit set at 30% of the income, whereas any higher loan principal at the start of the term would lead to a crossing of this limit. As existing loans are based on such an amortization table, the maximum loan principal will be limited by the maximum accepted monthly loan payment during the first year of the loan term. General price developments during the term of a loan, like inflation, and the gradual increase of wages, which usually correlate with these price developments, are not taken into account.

Actually, the annual income of the debtor is likely to increase as a result of price developments like inflation. Assuming that there is an annual inflation of 2% and an equal increase of the income of the debtor, the figures in the repayment table of the loan mentioned above would be as following:

| | | | | | Loan | Debt- |
|---|---|---|---|---|---|---|
| | Annual | Loan | Interest/ | Amorti- | payment/ | income |
| Year | income | principal | month | zation/month | month | ratio |
| 1 | $40,000 | $165,178 | $825.89 | $174.11 | $1,000.00 | 30% |
| 2 | $40,800 | $163,089 | $815.44 | $184.56 | $1,000.00 | 29% |
| 3 | $41,616 | $160,874 | $804.37 | $195.63 | $1,000.00 | 29% |
| 4 | $42,448 | $158,526 | $792.63 | $207.37 | $1,000.00 | 28% |
| 5 | $43,297 | $156,038 | $780.19 | $219.81 | $1,000.00 | 28% |
| 6 | $44,163 | $153,400 | $767.00 | $233.00 | $1,000.00 | 27% |
| 7 | $45,046 | $150,604 | $753.02 | $246.98 | $1,000.00 | 27% |
| 8 | $45,947 | $147,641 | $738.20 | $261.80 | $1,000.00 | 26% |
| 9 | $46,866 | $144,499 | $722.50 | $277.50 | $1,000.00 | 26% |
| 10 | $47,804 | $141,169 | $705.84 | $294.16 | $1,000.00 | 25% |
| 11 | $48,760 | $137,639 | $688.20 | $311.80 | $1,000.00 | 25% |
| 12 | $49,735 | $133,897 | $669.49 | $330.51 | $1,000.00 | 24% |
| 13 | $50,730 | $129,931 | $649.66 | $350.34 | $1,000.00 | 24% |
| 14 | $51,744 | $125,727 | $628.64 | $371.36 | $1,000.00 | 23% |
| 15 | $52,779 | $121,271 | $606.35 | $393.65 | $1,000.00 | 23% |
| 16 | $53,835 | $116,547 | $582.74 | $417.26 | $1,000.00 | 22% |
| 17 | $54,911 | $111,540 | $557.70 | $442.30 | $1,000.00 | 22% |
| 18 | $56,010 | $106,232 | $531.16 | $468.84 | $1,000.00 | 21% |
| 19 | $57,130 | $100,606 | $503.03 | $496.97 | $1,000.00 | 21% |
| 20 | $58,272 | $94,643 | $473.21 | $526.79 | $1,000.00 | 21% |
| 21 | $59,438 | $88,321 | $441.61 | $558.39 | $1,000.00 | 20% |
| 22 | $60,627 | $81,620 | $408.10 | $591.90 | $1,000.00 | 20% |
| 23 | $61,839 | $74,518 | $372.59 | $627.41 | $1,000.00 | 19% |
| 24 | $63,076 | $66,989 | $334.94 | $665.06 | $1,000.00 | 19% |
| 25 | $64,337 | $59,008 | $295.04 | $704.96 | $1,000.00 | 19% |
| 26 | $65,624 | $50,548 | $252.74 | $747.26 | $1,000.00 | 18% |
| 27 | $66,937 | $41,581 | $207.91 | $792.09 | $1,000.00 | 18% |
| 28 | $68,275 | $32,076 | $160.38 | $839.62 | $1,000.00 | 18% |
| 29 | $69,641 | $22,001 | $110.00 | $890.00 | $1,000.00 | 17% |
| 30 | $71,034 | $11,321 | $56.60 | $943.40 | $1,000.00 | 17% |
| | | $0 | | Σ = | | |
| | | | | $165,178 | | |

This table indicates that the fixed monthly loan payment of $1,000 leads to a diminishing debt-income ratio as a result of the increase of the income. At the start of the term the loan payment is 30% of the monthly income, whereas the monthly loan payment declines to only 17% of the monthly income by the end of this term. The invention, this patent application refers to, utilizes this principle.

### Practical Example I

In a first practical example of a loan in accordance with the invention the periodical loan payment is linked to the same index number, to which the income is adjusted. This is shown in the following table, assuming that the income and the amount of the monthly loan payments both increase 2% per year during the term of the loan.

| | | | | | Loan | Debt- |
|---|---|---|---|---|---|---|
| | Annual | Loan | Interest/ | Amortiza- | payment/ | income |
| Year | income | principal | month | tion/month | month | ratio |
| 1 | $40,000 | $205,387 | $1,026.94 | −$26.93 | $1,000.00 | 30% |
| 2 | $40,800 | $205,710 | $1,028.55 | −$8.55 | $1,020.00 | 30% |
| 3 | $41,616 | $205,813 | $1,029.06 | $11.34 | $1,040.40 | 30% |
| 4 | $42,448 | $205,677 | $1,028.38 | $32.82 | $1,061.21 | 30% |
| 5 | $43,297 | $205,283 | $1,026.41 | $56.02 | $1,082.43 | 30% |
| 6 | $44,163 | $204,611 | $1,023.05 | $81.03 | $1,104.08 | 30% |
| 7 | $45,046 | $203,638 | $1,018.19 | $107.97 | $1,126.16 | 30% |
| 8 | $45,947 | $202,343 | $1,011.71 | $136.97 | $1,148.69 | 30% |
| 9 | $46,866 | $200,699 | $1,003.50 | $168.16 | $1,171.66 | 30% |
| 10 | $47,804 | $198,681 | $993.41 | $201.69 | $1,195.09 | 30% |
| 11 | $48,760 | $196,261 | $981.30 | $237.69 | $1,218.99 | 30% |
| 12 | $49,735 | $193,409 | $967.04 | $276.33 | $1,243.37 | 30% |
| 13 | $50,730 | $190,093 | $950.46 | $317.78 | $1,268.24 | 30% |
| 14 | $51,744 | $186,279 | $931.40 | $362.21 | $1,293.61 | 30% |
| 15 | $52,779 | $181,933 | $909.66 | $409.82 | $1,319.48 | 30% |
| 16 | $53,835 | $177,015 | $885.07 | $460.79 | $1,345.87 | 30% |
| 17 | $54,911 | $171,485 | $857.43 | $515.36 | $1,372.79 | 30% |
| 18 | $56,010 | $165,301 | $826.51 | $573.74 | $1,400.24 | 30% |
| 19 | $57,130 | $158,416 | $792.08 | $636.16 | $1,428.25 | 30% |
| 20 | $58,272 | $150,782 | $753.91 | $702.90 | $1,456.81 | 30% |
| 21 | $59,438 | $142,348 | $711.74 | $774.21 | $1,485.95 | 30% |
| 22 | $60,627 | $133,057 | $665.28 | $850.38 | $1,515.67 | 30% |
| 23 | $61,839 | $122,852 | $614.26 | $931.72 | $1,545.98 | 30% |
| 24 | $63,076 | $111,672 | $558.36 | $1,018.54 | $1,576.90 | 30% |
| 25 | $64,337 | $99,449 | $497.25 | $1,111.19 | $1,608.44 | 30% |
| 26 | $65,624 | $86,115 | $430.58 | $1,210.03 | $1,640.61 | 30% |
| 27 | $66,937 | $71,595 | $357.97 | $1,315.44 | $1,673.42 | 30% |
| 28 | $68,275 | $55,809 | $279.05 | $1,427.84 | $1,706.89 | 30% |
| 29 | $69,641 | $38,675 | $193.38 | $1,547.65 | $1,741.02 | 30% |
| 30 | $71,034 | $20,103 | $100.52 | $1,675.33 | $1,775.84 | 30% |
| | | $0 | | Σ = | | |
| | | | | $205,387 | | |

This table shows that under comparable circumstances a loan principal of more than $205,000 can be granted on an annual income of $40,000 without causing the monthly loan payments to effectively cross the maximum limit of the debt-income ratio.

### Practical Example II

Apart from increasing the maximum of the loan principal, the invention can also be used in order to reduce the monthly loan payments at the beginning of the loan term. This has been incorporated in the following table, in which the income is annually adjusted to an index number of 2% and the monthly loan payment is linked to an index member of 3.3% per year.

| | | | | | Loan | Debt- |
|---|---|---|---|---|---|---|
| | Annual | Loan | Interest/ | Amortiza- | payment/ | income |
| Year | income | principal | month | tion/month | month | ratio |
| 1 | $40,000 | $165,178 | $825.89 | −$136.19 | $689.70 | 21% |
| 2 | $40,800 | $166,813 | $834.06 | −$121.60 | $712.46 | 21% |
| 3 | $41,616 | $168,272 | $841.36 | −$105.39 | $735.97 | 21% |
| 4 | $42,448 | $169,536 | $847.68 | −$87.42 | $760.26 | 21% |
| 5 | $43,297 | $170,586 | $852.93 | −$67.58 | $785.35 | 22% |
| 6 | $44,163 | $171,397 | $856.98 | −$45.72 | $811.26 | 22% |
| 7 | $45,046 | $171,945 | $859.73 | −$21.69 | $838.03 | 22% |
| 8 | $45,947 | $172,205 | $861.03 | $4.66 | $865.69 | 23% |
| 9 | $46,866 | $172,150 | $860.75 | $33.51 | $894.26 | 23% |
| 10 | $47,804 | $171,747 | $858.74 | $65.03 | $923.77 | 23% |
| 11 | $48,760 | $170,967 | $854.84 | $99.42 | $954.25 | 23% |
| 12 | $49,735 | $169,774 | $848.87 | $136.87 | $985.74 | 24% |
| 13 | $50,730 | $168,132 | $840.66 | $177.62 | $1,018.27 | 24% |
| 14 | $51,744 | $166,000 | $830.00 | $221.87 | $1,051.88 | 24% |
| 15 | $52,779 | $163,338 | $816.69 | $269.90 | $1,086.59 | 25% |
| 16 | $53,835 | $160,099 | $800.49 | $321.95 | $1,122.44 | 25% |
| 17 | $54,911 | $156,235 | $781.18 | $378.31 | $1,159.49 | 25% |
| 18 | $56,010 | $151,696 | $758.48 | $439.27 | $1,197.75 | 26% |
| 19 | $57,130 | $146,425 | $732.12 | $505.15 | $1,237.27 | 26% |
| 20 | $58,272 | $140,363 | $701.81 | $576.29 | $1,278.10 | 26% |
| 21 | $59,438 | $133,447 | $667.24 | $653.05 | $1,320.28 | 27% |
| 22 | $60,627 | $125,611 | $628.05 | $735.80 | $1,363.85 | 27% |
| 23 | $61,839 | $116,781 | $583.91 | $824.95 | $1,408.86 | 27% |
| 24 | $63,076 | $106,882 | $534.41 | $920.94 | $1,455.35 | 28% |
| 25 | $64,337 | $95,830 | $479.15 | $1,024.23 | $1,503.38 | 28% |
| 26 | $65,624 | $83,540 | $417.70 | $1,135.29 | $1,552.99 | 28% |
| 27 | $66,937 | $69,916 | $349.58 | $1,254.66 | $1,604.24 | 29% |
| 28 | $68,275 | $54,860 | $274.30 | $1,382.88 | $1,657.18 | 29% |
| 29 | $69,641 | $38,266 | $191.33 | $1,520.54 | $1,711.86 | 29% |
| 30 | $71,034 | $20,019 | $100.10 | $1,668.26 | $1,768.36 | 30% |
| | | $0 | | Σ = | | |
| | | | | $165,178 | | |

During the first years of the loan term there is no amortization. In fact the loan principal increases during these years. As a result of the annual indexing of the monthly loan payments, this process is turned around and from the eighth year the loan principal starts diminishing as such that during the remaining part of the term the loan principal is paid off completely. By applying the invention this way the monthly loan payments require only 21% of the monthly income at the beginning of the loan term, whereas the debt-income ratio of a conventional loan, as shown earlier, does not get beneath 26% during the first eight years of the term at a 2% annual increase of the income.

### Practical Example III

In addition to the possibility of altering the amount of the monthly loan payments, the invention can also be used in order to shorten the term of the loan. This has been applied in the following table, in which all other factors have remained the same as in the case of the conventional loan described earlier.

| | | | | | Loan | Debt- |
|---|---|---|---|---|---|---|
| | Annual | Loan | Interest/ | Amortiza- | payment/ | income |
| Year | income | principal | month | tion/month | month | ratio |
| 1 | $40,000 | $165,178 | $825.89 | $174.11 | $1,000.00 | 30% |
| 2 | $40,800 | $163,089 | $815.44 | $204.56 | $1,020.00 | 30% |
| 3 | $41,616 | $160,634 | $803.17 | $237.23 | $1,040.40 | 30% |
| 4 | $42,448 | $157,787 | $788.94 | $272.27 | $1,061.21 | 30% |
| 5 | $43,297 | $154,520 | $772.60 | $309.83 | $1,082.43 | 30% |
| 6 | $44,163 | $150,802 | $754.01 | $350.07 | $1,104.08 | 30% |
| 7 | $45,046 | $146,601 | $733.01 | $393.16 | $1,126.16 | 30% |
| 8 | $45,947 | $141,883 | $709.42 | $439.27 | $1,148.69 | 30% |
| 9 | $46,866 | $136,612 | $683.06 | $488.60 | $1,171.66 | 30% |
| 10 | $47,804 | $130,749 | $653.74 | $541.35 | $1,195.09 | 30% |
| 11 | $48,760 | $124,253 | $621.26 | $597.73 | $1,218.99 | 30% |
| 12 | $49,735 | $117,080 | $585.40 | $657.97 | $1,243.37 | 30% |
| 13 | $50,730 | $109,184 | $545.92 | $722.32 | $1,268.24 | 30% |
| 14 | $51,744 | $100,516 | $502.58 | $791.02 | $1,293.61 | 30% |
| 15 | $52,779 | $91,024 | $455.12 | $864.36 | $1,319.48 | 30% |
| 16 | $53,835 | $80,652 | $403.26 | $942.61 | $1,345.87 | 30% |
| 17 | $54,911 | $69,340 | $346.70 | $1,026.08 | $1,372.79 | 30% |
| 18 | $56,010 | $57,027 | $285.14 | $1,115.10 | $1,400.24 | 30% |
| 19 | $57,130 | $43,646 | $218.23 | $1,210.02 | $1,428.25 | 30% |
| 20 | $58,272 | $29,126 | $145.63 | $1,311.18 | $1,456.81 | 30% |
| 21 | $59,438 | $13,392 | $66.96 | $1,418.99 | $1,485.95 | 30% |
| | | −$3,636 | | Σ = | | |
| | | | | $168,814 | | |

This shows that by applying the invention in accordance with this practical example the loan principal can be paid off completely in less than 21 years, whereas the repayment of the same loan principal in the case of the conventional loan requires a loan term of 30 years.

Although the invention has been further described and explained on basis of a merely a few practical examples in the above, it may be obvious that the opportunities for the practical application of the invention are by no means limited to the given examples. In contrast a variety of uses and practical appearances in the implication of the invention are available to the average specialist. The invention can be applied in various ways. If within a certain tax system interest or amortization is to a certain extent tax-deductible, it is possible to apply the periodic adjustment to the index number upon the periodical loan payment either before or after tax deduction, depending on the tax environment. If the interest on mortgage loans is tax-deductible, the indexing of the periodical loan payment after tax deduction might be preferred. That way the purchasing power of the debtor is maintained over time. Should the interest in no way be tax-deductible, then the purchasing power would normally be maintained if the indexing is applied upon the gross loan payment. In addition the indexing of the periodical loan payment can be based on a true or a fictitious, possibly forecasted index number. In the case of a true index number every year the actual, official index number is applied. Should it concern a fictitious or estimated index number the periodical indexing can be fixed for the entire loan term at a level agreed to upfront or it can be forecasted on basis of the registered development over a number of recent years.

Furthermore, the loan term can be fixed or flexible. The flexible loan term ends when the loan principal has been amortized entirely, whereas the fixed loan ends at a maturity date leaving the debtor either with a remaining debt or with a surplus value, depending on the height of the index number during the term. The fixed term option can for instance be applied in case the amortization of the loan principal is covered by an endowment policy.

Moreover, the deviation of the index number can be—and is even likely to be—limited. In a financial product in accordance with the invention the index number has the effect of a multiplier on periodical loan payments. In times of deflation the loan payments would decrease over time if the minimum value of the index number is not limited to 1.00. Although this would seem an interesting weapon against deflation, in the long run such a development might cause solvency problems. On the other hand, a sudden steep rise in prices might also have undesirable effects for debtors should wages follow such a development with delay. Therefore, the settlement of a minimum and maximum value for the index number, between which it is allowed to fluctuate, would be an appropriate way to assure a proper course throughout the loan term.

A special application of the invention specifies the effect of a variable index number, possibly limited in its deviation, in the case of both a fixed and a flexible term, as following: a financial product in accordance with the invention wherein an allowed fluctuation of the index number affects either the term of the loan or the debt remaining at the end of said term, allowing said debt in case of a fixed term to be negative in the sense of constituting a surplus value in favour of the borrower.

The effect of the indexing in accordance with the invention depends on the combination with other parameters. Either it can shorten the term of the financial product compared to a construction without indexing. This leads to a reduction of the total amount of interest paid over the entire loan term. Or the indexing can be used in order to increase the maximum loan principal. Thanks to the indexing less amortization or even no amortization is required during the first years of the loan term. This principle extends the financial opportunities of the debtor and a comparatively higher loan principal can be applied for. Even a combination of these two options is possible, resulting in a higher loan principal and a lower total of loan payments. Besides or in addition to this there is the possibility of applying the periodical indexing during only a part of the loan term instead of during the entire term.

So far the discussion of the invention has been based on the comparison to a conventional loan with a fixed interest rate. This is a logical approach as both formulas are featured by this element. However, by placing the invention in a more complete range of existing loan types, a more precise image of its features can be exposed.

Until the creation of this invention the available mortgage types could be divided in two general categories: fixed interest rate loans and index-linked loans. The fixed rate loans give security over time against the influence of fluctuations in the interest or inflation rate by eliminating this influence. So the interests of neither the lender nor the debtor are affected by a change in the interest rate or the inflation rate, as shown in the following scheme:

| Fixed rate | Lender's interests | Debtor's interests |
|---|---|---|
| Interest/inflation increase | 0 | 0 |
| Interest/inflation decrease | 0 | 0 |

The index-linked loans, in which the interest rate and possibly other parameters are linked to one or more index numbers, are designed to let the loan float along with general economical developments. Should the interest rate or the inflation rate increase, so does the yield of the loan to the lender. The interests of the debtor, however, are opposed to those of the lender. For, in the case of an increasing interest or inflation rate, the debtor has to pay more for the money he borrowed. The interests of the borrower and the lender in the case of an index-linked loan can be displayed as following:

| Index-linked | Lender's interests | Debtor's interests |
|---|---|---|
| Interest/inflation increase | + | − |
| Interest/inflation decrease | − | + |

The invention, this description refers to, is an unexpected combination of elements from both classical categories mentioned above. On one hand it has an index-linked periodical payment which makes the speed of the amortization process accelerate or slow down in accordance with the general economical developments. And on the other hand it has a fixed interest rate which limits the deviation of the interest paid during the entire term. The influence this combination has on the debtor's and the lender's interests is even more peculiar than this combination itself.

For the debtor a rise of inflation means an acceleration of the amortization process. As the interest rate is fixed and the money is borrowed during a shorter term, less interest is paid over the entire term. Nevertheless, the amount of the periodical loan payments remains affordable as this level keeps pace with general price developments. Should the inflation rate decrease, then the amortization process is slowed down and the term of the loan gets longer. This means that the money is borrowed during a longer period and consequently, more interest has to be paid over the entire term. This, however, does not necessarily mean that more interest is paid than in the case of a conventional fixed interest rate loan, of which the amortization process could be interpreted as a zero-inflation example of the invention. Only if the loan in accordance with the invention has a periodical loan payment at the start of the term, in which a lower amount is meant for amortization than in the case of the conventional loan, then the total amount of interest paid in the case of the invention could end up higher compared to the conventional fixed interest rate loan in the event of a decrease of inflation.

From the lender's point of view the invention is also interesting. Should the inflation go down, then the reinvestment opportunities are likely to become less attractive. So the slackened amortization process of the loan means that the lender has to reinvest less money in lower yield reinvestments and the money remains invested in the loan with a comparatively high yield during a longer term. As a result the total yield of the loan itself rises. Should the inflation increase, however, then the yield on the loan itself diminishes, as a result of the accelerated amortization process and, consequently, the reduction of the interest paid over the entire term. For the lender this has the positive side effect that the money is available in an earlier stage for alternative investment opportunities with a higher yield, assuming that the increase of inflation comes with an increase of the interest rate. So in fact, the lender profits from both an increase and a decrease of inflation thanks to the effect the altered amortization process has on the reinvestment opportunities. Apart from these side effects the interests of the lender and the debtor are opposite in the case of a loan according to the invention, as shown in the following scheme:

| Invention | Lender's interests | Debtor's interests |
|---|---|---|
| Interest/inflation increase | − | + |
| Interest/inflation decrease | + | − |

By comparing the scheme of the conventional index-linked loan to that of the invention it becomes clear, that the interests of the lender in the case of the index-linked loan and in the case of the loan in accordance with the invention are the opposite. For the debtor this is the same. If the inflation rate or the interest rate increases, more interest has to be paid in the case of the index-linked loan, whereas less interest is paid in the case of the loan in accordance with the invention. As a matter of fact, the effects of a change in the inflation rate or the interest rate in the case of a conventional index-linked loan are opposed to those in the case of a loan in accordance with the invention, albeit that the effects in the latter case are likely to be less substantial. Due to the fixed interest rate the difference between the minimum and the maximum of the total amount of interest paid is limited. Nevertheless, in view of these opposite effects it would be negligent to qualify the invention as just another index-linked loan. Rather it would be qualified as a more customizable version of a fixed interest loan. This would place it in its appropriate opposition to loans with an index-linked interest rate. After all, the fixed interest rate, by which it is featured, has the effect of a sort of anchor limiting the deviation of the total amount of interest paid over the loan in the case of severe fluctuations of the interest rate. And with this it qualifies for the objective fixed interest rate loans are intended for: a limited exposure to general economical developments.

In the past a number of initiatives have been taken, in which periodical loan payments were index-linked. In all cases more than one parameter was index-linked. Apart from the interest rate, which was index-linked in all of these cases, also the loan principal, for instance, could be index-linked. As such a combination of index-linked parameters has an intensified effect, fluctuations in general economical developments are likely to have very serious financial consequences for the ones involved. Therefore, cautiousness usually caused a distance between supply and demand. In times when inflation is high and likely to decrease, debtors are more than willing to apply for such a loan, but lenders are reluctant to provide them, and vice versa.

In the late 1970's an index-linked mortgage was launched in England. At the time inflation was very high. There were enough applicants but the concept was taken off the market due to a lack of investors. In some cases, like in Canada and Denmark, the concept was applied in social housing programs. The index-linked mortgaging was intended to postpone government subsidies for these projects. And thus, the gap between supply and demand was narrowed by government subsidies.

As fluctuations in general economical developments have a similar, although intensified, effect in the case of such a combination of index-linked loan payments, an index-linked interest rate and possibly other index-linked parameters as in the case of a conventional index-linked loan as mentioned above, these examples of prior art are not being further discussed. It may be clear that the unexpected combination of the fixed interest rate and the index-linked loan payments as applied in the invention is new and that this combination has an effect, which is completely different from existing kinds of loans.

The addition of an indexing of the periodical loan payments provides applicants for fixed interest rate mortgages, loans and other financial products with more freedom of choice. One can choose between a construction in which less interest in paid and a construction in which a higher loan principal can be obtained. These options can even be combined. As a result of this extension of possibilities it is, for example, possible to obtain a higher loan principal without facing irresponsible debt payments. The required financial space is provided by the principle that the periodical loan payments grow along with the index-linked disposable income or profits of the debtor, whereas the fixed interest rate secures proportioned interest costs.

1. Financial product, in which an amount of money is provided as a loan principal in return for, at least partially, the obligation to make periodical payments on the loan during a term, wherein the amount of the periodical payments is index-linked during at least a part of the loan term to an index number, which refers to economical development and wherein the interest rate has a long term fixed character.

2. Financial product according to claim 1, wherein the index number is a price index number.

3. Financial product according to claim 2, wherein the index number is determined by the average inflation over an elapsed period.

4. Financial product according to claim 2, wherein the index number is calculated as a function of a forecasted annual inflation.

5. Financial product according to claim 4, wherein the index number has a long term fixed character.

6. Financial product according to claim 1, wherein the frequency of the obligatory periodical loan payments are set on a monthly basis and that the amount of the monthly loan payment is annually adjusted on basis of an index number.

7. Financial product according to claim 2, wherein the frequency of the obligatory periodical loan payments is set on a monthly basis and that the amount of the monthly loan payment is annually adjusted on basis of an index number.

8. Financial product according to claim 3, wherein the frequency of the obligatory periodical loan payments is set on a monthly basis and that the amount of the monthly loan payment is annually adjusted on basis of an index number.

9. Financial product according to claim 4, wherein the frequency of the obligatory periodical loan payments is set on a monthly basis and that the amount of the monthly loan payment is annually adjusted on basis of an index number.

10. Financial product according to claim 5, wherein the frequency of the obligatory periodical loan payments is set on a monthly basis and that the amount of the monthly loan payment is annually adjusted on basis of an index number.

11. Financial product according to claim 6, wherein the amount of the periodical loan payment is fixed for the period of a year until an annual adjustment.

12. Financial product according to claim 7, wherein the amount of the periodical loan payment is fixed for the period of a year until an annual adjustment.

13. Financial product according to claim 8, wherein the amount of the periodical loan payment is fixed for the period of a year until an annual adjustment.

14. Financial product according to claim 9, wherein the amount of the periodical loan payment is fixed for the period of a year until an annual adjustment.

15. Financial product according to claim 10, wherein the amount of the periodical loan payment is fixed for the period of a year until an annual adjustment.

16. Financial product according to claim 1, wherein an allowed fluctuation of the index number affects either the term of the loan or the debt remaining at the end of said term, allowing said debt in case of a fixed term to be negative in the sense of constituting a surplus value in favour of the borrower.

17. Financial product according to claim 2, wherein an allowed fluctuation of the index number affects either the term of the loan or the debt remaining at the end of said term, allowing said debt in case of a fixed term to be negative in the sense of constituting a surplus value in favour of the borrower.

18. Financial product according to claim 3, wherein an allowed fluctuation of the index number affects either the term of the loan or the debt remaining at the end of said term, allowing said debt in case of a fixed term to be negative in the sense of constituting a surplus value in favour of the borrower.

19. Financial product according to claim 4, wherein an allowed fluctuation of the index number affects either the term of the loan or the debt remaining at the end of said term, allowing said debt in case of a fixed term to be negative in the sense of constituting a surplus value in favour of the borrower.

20. Financial product according to claim 6, wherein an allowed fluctuation of the index number affects either the term of the loan or the debt remaining at the end of said term, allowing said debt in case of a fixed term to be negative in the sense of constituting a surplus value in favour of the borrower.

21. Financial product according to claim 7, wherein an allowed fluctuation of the index number affects either the term of the loan or the debt remaining at the end of said term, allowing said debt in case of a fixed term to be negative in the sense of constituting a surplus value in favour of the borrower.

22. Financial product according to claim 8, wherein an allowed fluctuation of the index number affects either the term of the loan or the debt remaining at the end of said term, allowing said debt to be negative in case of a fixed term.

23. Financial product according to claim 9, wherein an allowed fluctuation of the index number affects either the term of the loan or the debt remaining at the end of said term, allowing said debt in case of a fixed term to be negative in the sense of constituting a surplus value in favour of the borrower.

24. Financial product according to claim 11, wherein an allowed fluctuation of the index number affects either the term of the loan or the debt remaining at the end of said term, allowing said debt to be negative in case of a fixed term.

25. Financial product according to claim 12, wherein an allowed fluctuation of the index number affects either the term of the loan or the debt remaining at the end of said term, allowing said debt in case of a fixed term to be negative in the sense of constituting a surplus value in favour of the borrower.

26. Financial product according to claim 13, wherein an allowed fluctuation of the index number affects either the term of the loan or the debt remaining at the end of said term, allowing said debt in case of a fixed term to be negative in the sense of constituting a surplus value in favour of the borrower.

27. Financial product according to claim 14, wherein an allowed fluctuation of the index number affects either the term of the loan or the debt remaining at the end of said term, allowing said debt in case of a fixed term to be negative in the sense of constituting a surplus value in favour of the borrower.
